(19) United States
(12) Patent Application Publication
(10) Pub. No.: US 2022/0139145 A1
(43) Pub. Date: May 5, 2022

(54) SHEET PROCESSING APPARATUS

(71) Applicant: Glory Ltd., Himeji-shi (JP)

(72) Inventor: Takeshi YOKAWA, Hyogo (JP)

(73) Assignee: Glory Ltd., Himeji-shi (JP)

(21) Appl. No.: 17/574,561

(22) Filed: Jan. 13, 2022

Related U.S. Application Data
(63) Continuation of application No. PCT/JP2020/028160, filed on Jul. 20, 2020.

(30) Foreign Application Priority Data
Jul. 25, 2019 (JP) 2019-136791

(51) Int. Cl. G07D 11/50; E05G 1/02; G07D 11/14; G07D 11/13; G07D 11/23

(52) U.S. Cl. CPC G07D 11/50; E05G 1/02; G07D 2211/00; G07D 11/13; G07D 11/23; G07D 11/14

(57) ABSTRACT

Provided is a sheet processing apparatus including: a transport member that transports a sheet; a detection sensor that detects a number of the sheets transported by the transport member; a predetermined first winding storage, another first winding storage, and a temporary storage each of which stores the sheet transported by the transport member; and a control circuitry. A maximum number of the sheets stored in the temporary storage is smaller than a maximum number of the sheets stored in the predetermined first winding storage. The control circuitry controls the transport member such that the sheets stored in the predetermined first winding storage are temporarily stored in each of the other first winding storage and the temporary storage. The control circuitry controls the detection sensor such that the number of the sheets is detected while the sheets are transported.

### CROSS-REFERENCE TO RELATED APPLICATIONS

This application is a Bypass Continuation of International Patent Application No. PCT/JP2020/028160, filed on Jul. 20, 2020, which claims priority to Japanese Patent Application No. 2019-136791, filed on Jul. 25, 2019, the entire contents of each are incorporated herein by reference.

### TECHNICAL FIELD

The present disclosure relates to a sheet processing apparatus.

### BACKGROUND

In the related art, there is known a sheet processing apparatus that deposits and dispenses banknotes. The conventional apparatus discloses reconciliation processing of feeding out every banknote stored in a storage module once, recognizing and counting the banknotes by a recognition unit, and returning the banknotes to the storage module again. The conventional apparatus discloses that in the reconciliation processing, another storage module or a temporary storage unit is used as a storage destination of banknotes fed out from the storage module.

### SUMMARY

A sheet processing apparatus of the present disclosure comprises: a transport member configured to transport a sheet; a detection sensor configured to detect a number of the sheets transported by the transport member; a first storage, a second storage, and a third storage each of which is configured to store the sheet transported by the transport member; and a control circuitry. A maximum number of the sheets stored in the third storage is smaller than a maximum number of the sheets stored in the first storage. The control circuitry controls the transport member such that the sheets stored in the first storage are temporarily stored in each of the second storage and the third storage, and the control circuitry controls the detection sensor such that the number of the sheets is detected while the sheets are transported.

### BRIEF DESCRIPTION OF DRAWINGS

FIG. 1A is a schematic view illustrating internal structures of sheet processing apparatuses according to Embodiments 1, 2 and 7 and a reference embodiment of the present disclosure;

FIG. 1B is a schematic view of a first sensor and a second sensor of a first winding storage unit of the sheet processing apparatuses;

FIG. 2 is a perspective view of a temporary storage unit of the sheet processing apparatuses;

FIG. 3 is a perspective view of the first winding storage unit of the sheet processing apparatuses;

FIG. 4 is a block diagram illustrating a configuration of the sheet processing apparatuses;

FIG. 5 illustrates a flowchart for reconciliation processing according to Embodiments 1 to 5;

FIG. 6A is a diagram for describing an operation of reconciliation processing according to Embodiment 1;

FIG. 6B is a diagram for describing an operation of the reconciliation processing according to Embodiment 1;

FIG. 6C is a diagram for describing an operation of the reconciliation processing according to Embodiment 1;

FIG. 6D is a diagram for describing an operation of the reconciliation processing according to Embodiment 1;

FIG. 6E is a diagram for describing an operation of the reconciliation processing according to Embodiment 1;

FIG. 7 is a schematic view illustrating an internal structure of sheet processing apparatuses according to Embodiments 3 to 6 of the present disclosure; and

FIG. 8 illustrates a flowchart for mixed dispensing processing according to Embodiment 7; and

FIG. 9 is a block diagram of control circuitry that performs computer-based operations in accordance with the present disclosure.

### DETAILED DESCRIPTION

The configuration as in the above conventional apparatus requires configuring such that the maximum number of banknotes stored in the storage module or the temporary storage unit as the storage destination is larger than the maximum number of banknotes stored in the storage module as the feeding source, and is therefore incapable of easily miniaturizing the apparatus.

An object of the present disclosure is to provide a sheet processing apparatus which can be easily miniaturized.

According to the present disclosure, it is possible to provide a sheet processing apparatus which can be easily miniaturized.

Hereinafter, embodiments of the present disclosure will be described with reference to the accompanying drawings. In the present embodiment, a sheet processing apparatus that deposits and dispenses banknotes that are an example of sheets will be exemplified. The sheets are not limited to banknotes, but may be vouchers, securities, ballots, and the like. Note that, in the following description, the “front” of the sheet processing apparatus means a side of an operator who performs at least one operation of sheet placement operation and sheet discharge operation through an opening provided in a processing unit, and the “rear” of the sheet processing apparatus means the opposite side thereto. In other words, the “front” of the sheet processing apparatus means a side provided with an opening for performing at least one operation of sheet placement operation and sheet discharge operation. Further, the “left” of the sheet processing apparatus means the left side when viewed from the operator facing the opening, and the “right” of the sheet processing apparatus means the right side when viewed from the operator facing the opening.

The functionality of the elements disclosed herein may be implemented using circuitry or control circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered control circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### (1) Embodiment 1

### (1-1) Configuration of Sheet Processing Apparatus

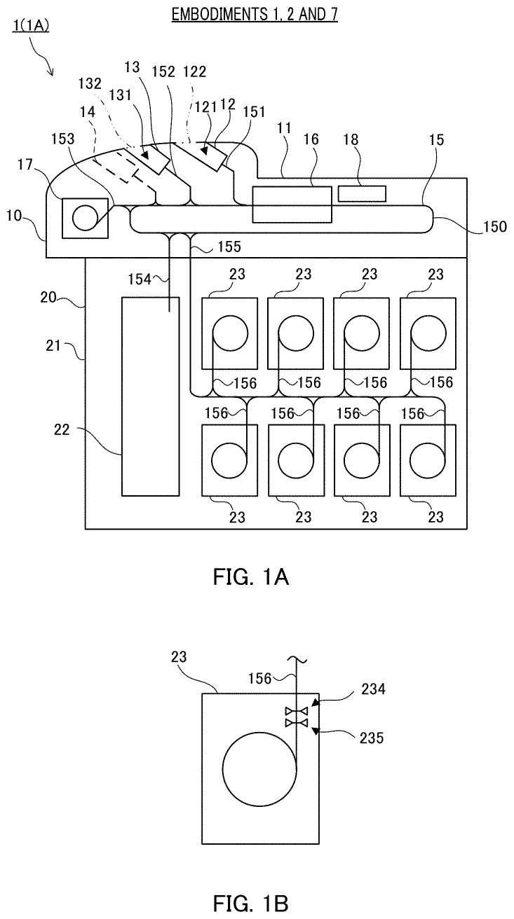

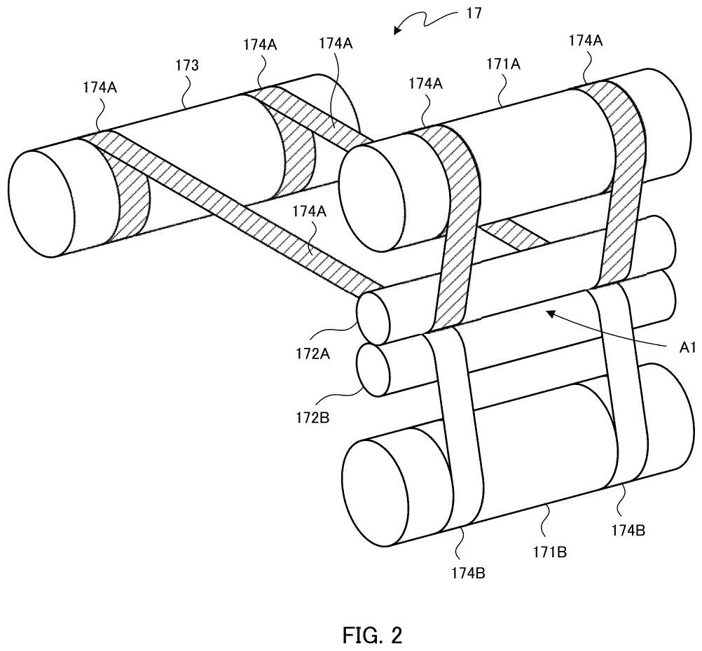

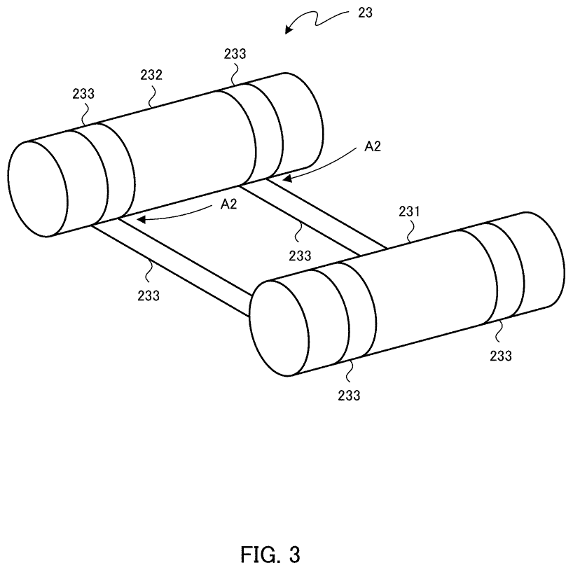

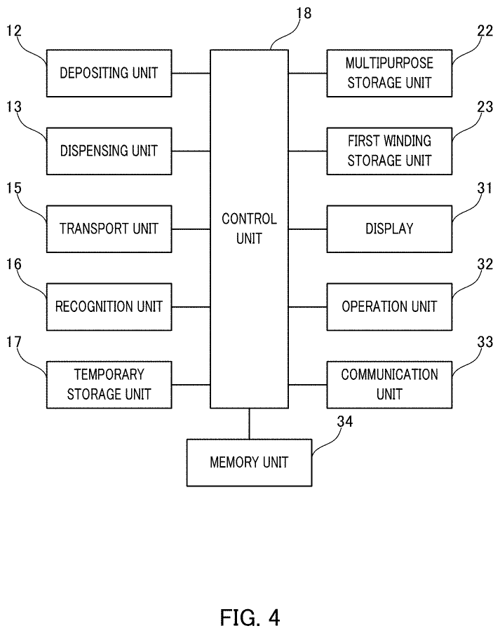

First, a sheet processing apparatus according to Embodiment 1 of the present disclosure will be described. FIG. 1A is a schematic view illustrating an internal structure of a sheet processing apparatus 1. FIG. 1B is a schematic view of a first sensor 234 and a second sensor 235 of a first winding storage unit 23. FIG. 2 is a perspective view of a temporary storage unit 17. FIG. 3 is a perspective view of the first winding storage unit 23. FIG. 4 is a block diagram illustrating a configuration of the sheet processing apparatus. Note that, in FIG. 1A, the left side represents a front portion of the sheet processing apparatus 1, and the right side represents a rear portion of the sheet processing apparatus 1.

The sheet processing apparatus 1 illustrated in FIG. 1A is a banknote depositing and dispensing machine that deposits and dispenses banknotes as sheets. The sheet processing apparatus 1 comprises a processing unit 10, and a storage box 20 provided below the processing unit 10. The processing unit 10 can be drawn forward with respect to the storage box 20.

The processing unit 10 comprises an upper housing 11. In a front portion of the upper housing 11, that is, in a front portion of the processing unit 10, an inlet (opening) 121 and an outlet (opening) 131 are provided. The inlet 121 is an example of an inlet unit of the present disclosure. The outlet 131 is an example of an outlet unit of the present disclosure. Inside the upper housing 11, that is, inside the processing unit 10, a transport unit 15, a recognition unit 16, the temporary storage unit 17, and a control unit 18 are disposed. The transport unit 15 is a transport member that forms a transport path. The recognition unit 16 is a recognition circuitry, and is an example of the detection sensor of the present disclosure. The temporary storage unit 17 is an example of the third storage unit of the present disclosure. The control unit 18 includes a control circuitry.

Near the inlet 121, a banknote feeding mechanism that feeds out banknotes one by one to the transport unit 15 in a predetermined cycle is disposed. The inlet 121 and the banknote feeding mechanism form a depositing unit 12.

Near the outlet 131, a stacking mechanism that piles up banknotes is disposed. The outlet 131 and the stacking mechanism form a dispensing unit 13. A second dispensing unit 14 having the same configuration as that of the dispensing unit 13 may be provided next to the dispensing unit 13 as needed. Further, the second dispensing unit 14 may have a different configuration from that of the dispensing unit 13.

Note that, in the front portion of the processing unit 10, only one of the depositing unit 12 and the dispensing unit 13 may be provided as needed. Further, a depositing and dispensing unit may be provided by providing an inlet/outlet through which both depositing and dispensing of banknotes are performed, and by disposing a banknote feeding mechanism and a stacking mechanism around the inlet/outlet. The inlet/outlet is an example of an inlet and outlet unit of the present disclosure.

The transport unit 15 transports banknotes at a predetermined transport speed. The transport unit 15 is formed of a belt mechanism or a roller mechanism that transports banknotes. The transport unit 15 comprises a loop-shaped transport path 150 that enables banknotes to be transported in one direction and in a direction opposite to the one direction, and a first diversion path 151, a second diversion path 152, a third diversion path 153, a fourth diversion path 154, a fifth diversion path 155, and a sixth diversion path 156 that are diverged from the loop-shaped transport path 150. The first diversion path 151 to the fourth diversion path 154 connect the loop-shaped transport path 150 with the depositing unit 12, the dispensing unit 13, the temporary storage unit 17, and a multipurpose storage unit 22 to be described later, respectively. The fifth diversion path 155 and the sixth diversion path 156 connect the loop-shaped transport path 150 with the first winding storage units 23 to be described later.

The recognition unit 16 comprises a sensor such as an image sensor, an optical sensor, and a magnetic sensor, and counts the number of banknotes transported by the transport unit 15 and recognizes the authenticity, denomination, fitness, and the like of a banknote.

The temporary storage unit 17 temporarily stores banknotes. The temporary storage unit 17 takes in and stores banknotes one by one, and feeds out banknotes stored therein one by one. The temporary storage unit 17 is formed of a winding storage unit in which a plurality of banknotes is stored in a state of being wound around a rotating body as illustrated in FIG. 2. The temporary storage unit 17 comprises second reels 171A and 171B, second rollers 172A and 172B, second drum 173, two second tapes 174A, and two second tapes 174B.

One ends of the two second tapes 174A are apart from each other by a predetermined distance and are connected to the second reel 171A. The second reel 171B is disposed such that its axis of rotation is parallel to the axis of rotation of the second reel 171A. One ends of the two second tapes 174B are apart from each other by the same distance as that for the second tape 174A and are connected to the second reel 171B.

The second rollers 172A and 172B are disposed such that their axes of rotation are parallel to each axis of rotation of the second reels 171A and 171B. The second rollers 172A and 172B are disposed so as to overlap each of the two second tapes 174A drawn from the second reel 171A and each of the two second tapes 174B drawn from the second reel 171B, and to hold the overlapped tapes therebetween.

The second drum 173 is disposed such that its axis of rotation is parallel to each axis of rotation of the second reels 171A and 171B and the second rollers 172A and 172B. The other ends of the second tapes 174A and 174B are connected to the second drum 173.

A banknote transported through the third diversion path 153 is inserted between the second tapes 174A drawn from the second reel 171A and the second tapes 174B drawn from the second reel 171B as indicated by an arrow A1. The banknote inserted therebetween in this way is wound together with the second tapes 174A and 174B around the second drum 173 by the rotations of the second reels 171A and 171B and the second drum 173. Further, the banknote wound around the second drum 173 is released from the second drum 173 by the rotations of the second reels 171A and 171B and the second drum 173 and is fed out to the third diversion path 153.

Note that, it may also be configured such that each of the second reels 171A and 172A is divided into two at a predetermined position along the axis of rotation, a half of the second reel 171A and a half of the first second roller 172A move one of the second tapes 174A, and the other half of the second reel 171A and the other half of the second roller 172A move the other one of the second tapes 174A. The same applies to the second reel 171B and the second roller 172B as well. In addition, each number of the second tapes 174A and 174B that form the temporary storage unit 17 may be one or may be three or more. In addition, the second rollers 172A and 172B may be omitted. Further, the temporary storage unit 17 may be formed of a stacking storage unit in which a plurality of banknotes is stored in a state of being stacked or may have the same configuration as a configuration of the first winding storage unit 23. The configuration of the first winding storage unit 23 will be described later.

The storage box 20 can be formed of, for example, a safe, and forms a lower housing 21. In a front portion or a rear portion of the lower housing 21, a storage box door that is lockable is provided. Inside the storage box 20, in order from a front portion thereof, one multipurpose storage unit 22 and eight first winding storage units 23 are disposed.

The multipurpose storage unit 22 is a stacking storage unit in which a plurality of banknotes is stored in a state of being stacked. The multipurpose storage unit 22 is a banknote storage unit usable for various purposes, and is used, for example, for storing overflow banknotes, dispensing reject banknotes, banknotes left behind, counterfeit notes, and suspect notes. The overflow banknote refers to a banknote that cannot be stored in a storage unit (the first winding storage unit 23) that is to store the banknote because the storage unit becomes full. Further, the dispensing reject banknote refers to, among banknotes fed out from the first winding storage unit 23 when banknote dispensing processing is performed, a banknote that cannot be recognized as normal by the recognition unit 16 due to transport abnormality such as skewing. Further, the banknote left behind refers to a banknote that is once dispensed to the dispensing unit 13, but then has not been taken out from the dispensing unit 13 for a predetermined time. Inside the multipurpose storage unit 22, a stacking table that ascends and descends in accordance with the amount of banknotes stacked thereon is disposed. The multipurpose storage unit 22 is configured to be capable of stacking and storing banknotes transported via the fourth diversion path 154 on the stacking table and feeding out banknotes stacked on the stacking table to the fourth diversion path 154 one by one from above.

The sixth diversion paths 156 diverged from the fifth diversion path 155 are connected to the eight first winding storage units 23, respectively. The eight first winding storage units 23 store, among banknotes sorted based on authenticity, fitness, denomination and the like, banknotes of specific kinds. The eight first winding storage units 23 may store banknotes of kinds different from each other. Further, at least two of the first winding storage units 23 may store banknotes of the same kind. The first winding storage unit 23 takes in and stores banknotes one by one, and feeds out banknotes stored therein one by one. The eight first winding storage units 23 are formed of a common unit, and are set to have the same maximum number of banknotes stored therein. The eight first winding storage units 23 are configured such that the maximum number of banknotes stored therein is larger than the maximum number of banknotes stored in the temporary storage unit 17. The first winding storage unit 23 comprises a first reel 231, a first drum 232, and two first tapes 233 as illustrated in FIG. 3.

One ends of the two first tapes 233 are apart from each other by a predetermined distance and are connected to the first reel 231.

The first drum 232 is disposed such that its axis of rotation is parallel to the axis of rotation of the first reel 231. The other ends of the first tapes 233 are connected to the first drum 232.

A banknote transported through the sixth diversion path 156 is drawn from the first reel 231 and is inserted between the first tapes 233 before being wound around the first drum 232 and the first tapes 233 each of which is wound around the first drum 232 on an outermost periphery as indicated by arrows A2. The banknote inserted therebetween in this way is wound together with the first tapes 233 around the first drum 232 by the rotations of the first reel 231 and the first drum 232. Further, the banknote wound around the first drum 232 is released from the first drum 232 by the rotations of the first reel 231 and the first drum 232 and is fed out to the sixth diversion path 156.

Note that, the number of first tapes 233 that form the first winding storage unit 23 may be one or may be three or more. Further, the first winding storage unit 23 may be formed of a stacking storage unit in which a plurality of banknotes is stored in a state of being stacked or may have the same configuration as the configuration of the temporary storage unit 17.

The control unit 18 comprises at least a central processing unit (CPU) and a memory. As illustrated in FIG. 4, the depositing unit 12, the dispensing unit 13, the transport unit 15, the temporary storage unit 17, the multipurpose storage unit 22, and the first winding storage unit 23 are connected to the control unit 18 such that signals can be transmitted and received therebetween. The depositing unit 12, the dispensing unit 13, the transport unit 15, the temporary storage unit 17, the multipurpose storage unit 22, and the first winding storage unit 23 described above comprise sensors that detect a banknote during transport. For example, each of the first winding storage units 23 is provided with the first sensor 234 and the second sensor 235 that are arranged in a direction in which a banknote is transported as illustrated in FIG. 1B. The control unit 18 is capable of recognizing a direction in which a banknote is transported based on a difference between timings of banknote detection by the first sensor 234 and the second sensor 235 that are arranged in the above-described manner. When detection signals of these sensors are inputted, the control unit 18 outputs a control signal based on the detection signals, and controls each unit forming the sheet processing apparatus 1 such that a banknote is transported among the depositing unit 12, the dispensing unit 13, the temporary storage unit 17, the multipurpose storage unit 22, and the first winding storage unit 23 via the transport unit 15. Further, the recognition unit 16, a display 31, an operation unit 32, a communication unit 33, and a memory unit 34 are connected to the control unit 18.

The display 31 is formed of, for example, a flat panel display, and displays various information.

The operation unit 32 functions as a human interface portion for an operator of the sheet processing apparatus 1. Note that, the display 31 and the operation unit 32 may be integrated by configuring such that the display 31 also functions as an operation unit by using a touch screen display.

The communication unit 33 allows the sheet processing apparatus 1 to transmit and receive signals to and from a higher-ranking terminal and another apparatus via a local area network (LAN) or a serial bus, for example.

The memory unit 34 is formed of, for example, a general-purpose storage device such as a hard disk drive and a flash memory. The memory unit 34 records, of each number of banknotes stored in the sheet processing apparatus 1 for each denomination and an inventory amount that represents an amount of banknotes stored therein, at least each number of banknotes stored therein for each denomination. For example, the memory unit 34 records, of each number of banknotes stored in each storage unit for each denomination and an inventory amount that represents an amount of banknotes stored therein, at least each number of banknotes stored therein for each denomination. Further, the memory unit 34 records each inventory amount of the multipurpose storage unit 22 and the first winding storage units 23. The memory unit 34 records a serial number list in which serial numbers of banknotes stored in the multipurpose storage unit 22 and the first winding storage units 23 are associated with consecutive numbers corresponding to the number of the banknotes stored therein. The serial numbers of the serial number list are arranged in the order in which the banknotes are stored in the multipurpose storage unit 22 and the first winding storage units 23. The memory unit 34 records the history of various processing executed by the sheet processing apparatus 1 as a log.

### (1-2) Processing of Sheet Processing Apparatus

(1-2-1) Depositing Processing

First, as processing of the sheet processing apparatus 1, depositing processing will be described. The depositing processing refers to processing of recognizing a banknote fed out from the depositing unit 12 and storing a banknote recognized as normal (normal banknote) inside the sheet processing apparatus 1.

An operator places banknotes into the inlet 121, and inputs a command to start depositing processing into the sheet processing apparatus 1 by operating the higher-ranking terminal or the operation unit 32. The banknotes in the inlet 121 are fed out one by one by the banknote feeding mechanism of the depositing unit 12, and are then transported to the recognition unit 16 through the transport unit 15. The recognition unit 16 recognizes and counts the banknotes. The transport unit 15 stores, among the banknotes processed by the recognition unit 16, normal banknotes in the temporary storage unit 17 through the loop-shaped transport path 150 and the third diversion path 153. On the other hand, the transport unit 15 transports, among the banknotes processed by the recognition unit 16, reject banknotes, which are not recognized as normal, to the outlet 131 through the loop-shaped transport path 150 and the second diversion path 152.

When the counting of every deposited banknote is completed by feeding out the every banknote placed into the inlet 121, the higher-ranking terminal or the display 31 displays a counting result. The operator confirms the counting result and then performs a predetermined storage operation on the higher-ranking terminal or the operation unit 32. This storage operation causes the temporary storage unit 17 to feed out banknotes stored therein one by one. The transport unit 15 stores each of the fed-out banknotes in the first winding storage unit 23 that is predetermined, through the third diversion path 153, the loop-shaped transport path 150, the fifth diversion path 155, and the sixth diversion path 156 based on a recognition result by the recognition unit 16 and a storage allocation set in advance. Note that, when the operator performs a predetermined canceling operation instead of the storage operation, the transport unit 15 dispenses the banknotes stored in the temporary storage unit 17 to the outlet 131. When the depositing processing ends, the control unit 18 updates the inventory amount, the serial number list and the like that have been recorded in the memory unit 34.

Note that, in the present item of (1-2-1) depositing processing, an example in which normal banknotes are once stored in the temporary storage unit 17 and are then stored in the first winding storage unit 23 that is predetermined has been described. In the depositing processing, however, normal banknotes may be stored in the first winding storage unit 23 that is predetermined, without using (causing the normal banknotes to pass through) the temporary storage unit 17.

(1-2-2) Dispensing Processing

Next, dispensing processing in the sheet processing apparatus 1 will be described. The dispensing processing refers to processing of dispensing a banknote stored inside the sheet processing apparatus 1.

An operator inputs a command to start dispensing processing for specifying a denomination of banknotes and a number of the banknotes into the sheet processing apparatus 1 by operating the higher-ranking terminal or the operation unit 32. The first winding storage unit 23 that stores banknotes of the specified denomination feeds out the specified number of banknotes stored therein. The transport unit 15 then transports the fed-out banknotes to the recognition unit 16 through the sixth diversion path 156, the fifth diversion path 155, and the loop-shaped transport path 150. The transport unit 15 dispenses the banknotes recognized by the recognition unit 16 to the outlet 131 through the loop-shaped transport path 150 and the second diversion path 152. When the dispensing processing ends, the control unit 18 updates the inventory amount, the serial number list or the like that have been recorded in the memory unit 34.

(1-2-3) Reconciliation Processing

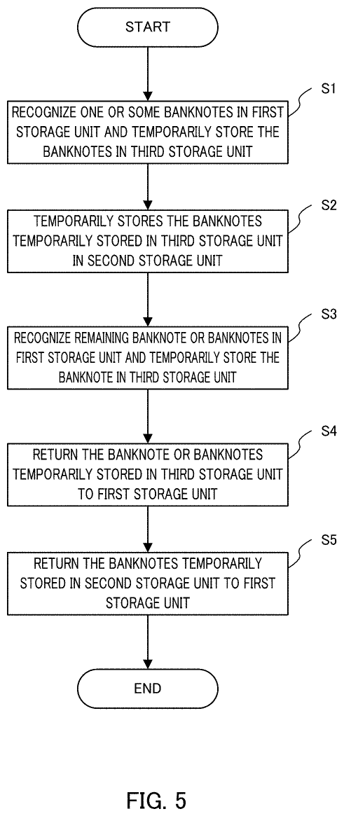

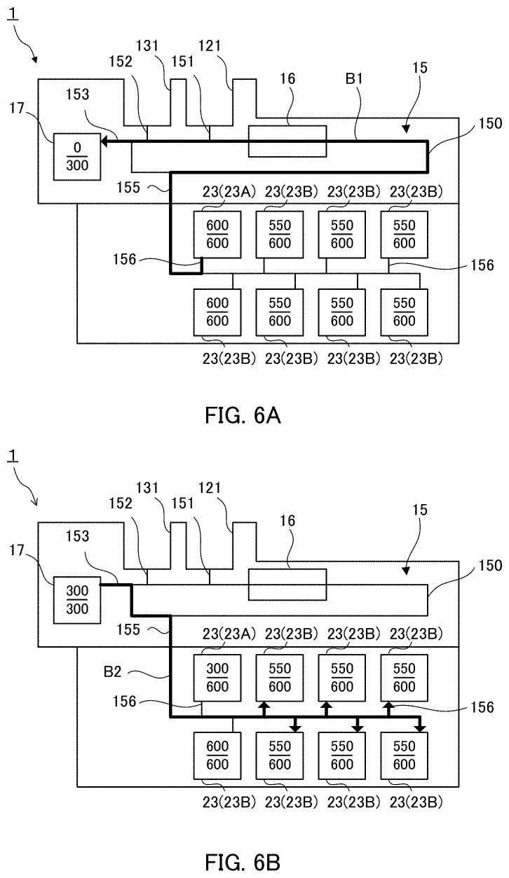

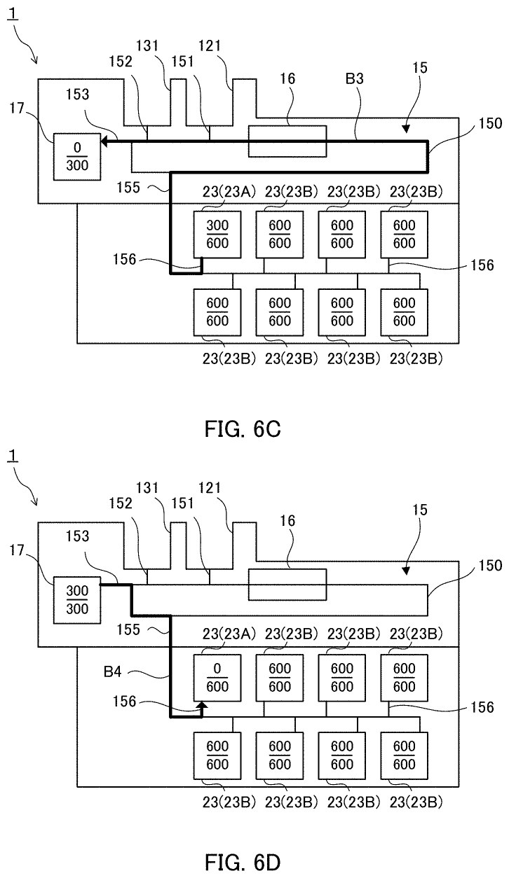

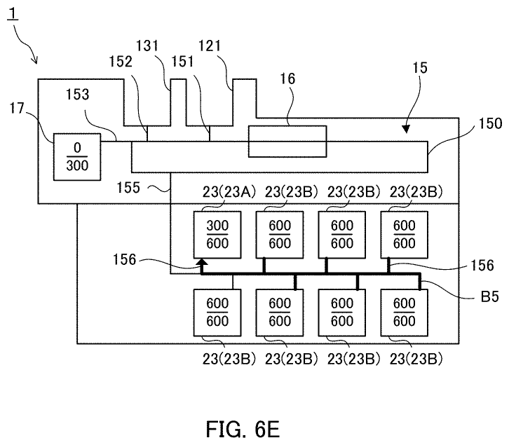

Next, reconciliation processing in the sheet processing apparatus 1 will be described. The reconciliation processing refers to processing of performing reconciliation of every banknote stored in at least one of the multipurpose storage unit 22 and the first winding storage units 23. The reconciliation processing is performed, for example, when an error occurs at the time of depositing processing or when the storage box door of the storage box 20 is opened or closed. FIG. 5 illustrates a flowchart for the reconciliation processing. FIGS. 6A to 6E are diagrams for describing operations of the reconciliation processing. Note that, although recognition of a number of banknotes, a denomination of a banknote, and a serial number of a banknote is exemplified as the contents of the reconciliation, at least a number of banknotes may be detected. Further, among the numbers in the quadrilaterals indicating the temporary storage unit 17 and the first winding storage units 23 in FIGS. 6A to 6E, each number on the lower side of the horizontal line indicates the maximum number of banknotes stored in each unit, and each number on the upper side of the horizontal line indicates the number of banknotes already stored in each unit. For example, FIG. 6A indicates that the maximum number of banknotes stored in the temporary storage unit 17 is 300, and each maximum number of banknotes stored in all the first winding storage units 23 is 600. Further, FIG. 6A indicates that the number of banknotes stored in the temporary storage unit 17 is 0, each number of banknotes stored in two of the first winding storage units 23, which are located upward and downward at the left end, is 600, and each number of banknotes stored in the first winding storage units 23 other then the two first winding storage units 23 is 550. That is, FIG. 6A indicates that the number of banknotes that can be stored (hereinafter referred to as “storage available capacity number”) in the temporary storage unit 17 is 300, each storage available capacity number in the two first winding storage units 23 located upward and downward at the left end is 0, and each storage available capacity number in the six first winding storage units 23 other then the two first winding storage units 23 is 50, respectively.

In Embodiment 1, reconciliation of banknotes stored in the first winding storage unit 23 on the upper-left side among the eight first winding storage units 23 illustrated in FIG. 1A and FIGS. 6A to 6E will be described. Hereinafter, the first winding storage unit 23 on the upper-left side for which the reconciliation is to be described will be referred to as “first storage unit 23A”, and each of the first winding storage units 23 other than the first storage unit 23A will be referred to as “second storage unit 23B”. Table 1 indicates configurations corresponding to the first storage unit, the second storage unit and the third storage unit of the present disclosure in Embodiment 1, respectively.

TABLE 1

| | |
|---|---|
| First storage unit | First winding storage unit 23 on the upper-left side |
| Second storage unit | First winding storage units 23 other than first |
| | winding storage unit 23 on the upper-left side |
| Third storage unit | Temporary storage unit 17 |

When reconciliation for the first storage unit 23A is performed, the control unit 18 first controls each unit of the sheet processing apparatus 1 such that one or some banknotes in the first storage unit 23A are recognized by the recognition unit 16 and are temporarily stored in the third storage unit (hereinafter referred to as “temporary storage unit 17” in the description of this reconciliation processing) as illustrated in FIG. 5 (S1). At this time, the control unit 18 recognizes each storage available capacity number in the temporary storage unit 17 and all the second storage units 23B based on information recorded in the memory unit 34. Next, when the control unit 18 recognizes that the sum of the storage available capacity number in the temporary storage unit 17 and the storage available capacity numbers of all the second storage units 23B is larger than the number of banknotes in the first storage unit 23A, the first storage unit 23A feeds out banknotes such that the number of banknotes remaining in the first storage unit 23A becomes equal to or smaller than the total storage available capacity number in all the second storage units 23B. For example, in a case where the storage available capacity number in the temporary storage unit 17 is 300, the number of banknotes in the first storage unit 23A is 600, and the total storage available capacity number in all the second storage units 23B is 300 as illustrated in FIG. 6A, the first storage unit 23A feeds out 300 banknotes. Then the transport unit 15 temporarily stores the fed-out banknotes in the temporary storage unit 17 through the sixth diversion path 156, the fifth diversion path 155, the loop-shaped transport path 150, and the third diversion path 153 as indicated by an arrow B1 in FIG. 6A. While or after the banknotes are temporarily stored in the temporary storage unit 17, the control unit 18 updates the serial number list or the like in the memory unit 34. As a result of the processing described above, the numbers of banknotes stored in the temporary storage unit 17, the first storage unit 23A, and the second storage units 23B are as illustrated in FIG. 6B.

Next, the transport unit 15 temporarily stores the banknotes temporarily stored in the temporary storage unit 17 in the second storage units 23B as illustrated in FIG. 5 (S2). At this time, the transport unit 15 may preferentially store the banknotes fed out from the temporary storage unit 17 in the second storage unit(s) 23B located on an upstream side of the banknote transport at the time of storage (the left side in FIG. 6B). For example, in a case where banknotes can be stored in six of the second storage units 23B, but every banknote in the temporary storage unit 17 can be stored in one or two of the second storage units 23B, where the one or two second storage units 23B are located on the upstream side of the banknote transport, the transport unit 15 may not disperse the banknotes in the six second storage units 23B, but may store the banknotes only in the one or two second storage units 23B. Here, the second storage unit(s) 23B located on the upstream side of the banknote transport mean the second storage unit(s) 23B for which the banknote transport path from the temporary storage unit 17 is shorter. Such a configuration makes it possible to shorten the banknote transport path at the time of storage and to reduce the risk of occurrence of clogging (jams) of banknotes or the like.

Further, the transport unit 15 may preferentially store the banknotes fed out from the temporary storage unit 17 in the second storage unit(s) 23B with a large storage available capacity number. For example, in a case where banknotes can be stored in six of the second storage units 23B, but every banknote in the temporary storage unit 17 can be stored in one or two of the second storage units 23B, where the one or two second storage units 23B have a large storage available capacity number, the transport unit 15 may not disperse the banknotes in the six second storage units 23B, but may store the banknotes only in the one or two second storage units 23B. Such a configuration makes it possible to reduce the number of second storage units 23B used in banknote storage. Accordingly, it is possible to reduce the number of switching from the fifth diversion path 155 to the sixth diversion path 156 at the time of banknote storage, and it is possible to reduce the risk of occurrence of jams or the like at the time of the switching.

Further, the transport unit 15 may store the banknotes fed out from the temporary storage unit 17 in every second storage unit 23B capable of storing the banknotes. At this time, the transport unit 15 may store the banknotes such that the numbers of banknotes temporarily stored in each of the second storage units 23B become the same, or may store the banknotes such that the numbers of banknotes stored in each of the second storage units 23B after temporary storage become the same.

In the case as illustrated in FIG. 6B, the transport unit 15 temporarily stores 300 banknotes in the temporary storage unit 17 in six of the second storage units 23B, with 50 banknotes for each second storage unit 23B, through the third diversion path 153, the loop-shaped transport path 150, the fifth diversion path 155, and each of the sixth diversion paths 156 as indicated by an arrow B2 in FIG. 6B. While or after the banknotes are temporarily stored in the second storage units 23B, the control unit 18 updates the serial number list or the like in the memory unit 34. As a result of the processing described above, the numbers of banknotes stored in the temporary storage unit 17, the first storage unit 23A, and the second storage units 23B are as illustrated in FIG. 6C.

Note that, when the banknotes are temporarily stored in the second storage units 23B, it may be configured as below in order to facilitate a distinction between temporarily stored banknotes and banknotes stored in the second storage units 23B before the temporary storage. That is, the gap between a banknote, which has been stored first among temporarily stored banknotes, and a banknote, which has been stored last among banknotes stored in the second storage units 23B before the temporary storage, may be configured to be larger than the gap between the temporarily stored banknotes and the gap between the banknotes stored in the second storage units 23B before the temporary storage. Further, when the banknotes are temporarily stored in the second storage units 23B, recognition processing by the recognition unit 16 may be performed.

Next, the control unit 18 controls each unit of the sheet processing apparatus 1 such that remaining banknote or banknotes in the first storage unit 23A are recognized by the recognition unit 16 and are temporarily stored in the temporary storage unit 17 as illustrated in FIG. 5 (S3). At this time, the transport unit 15 stores 300 banknotes fed out from the first storage unit 23A in the temporary storage unit 17 through the sixth diversion path 156, the fifth diversion path 155, the loop-shaped transport path 150, and the third diversion path 153 as indicated by an arrow B3 in FIG. 6C, for example. While or after the banknote or banknotes are temporarily stored in the temporary storage unit 17, the control unit 18 updates the serial number list or the like in the memory unit 34. As a result of the processing described above, the numbers of banknotes stored in the temporary storage unit 17, the first storage unit 23A, and the second storage units 23B are as illustrated in FIG. 6D.

Thereafter, the transport unit 15 returns the banknote or banknotes temporarily stored in the temporary storage unit 17 to the first storage unit 23A as illustrated in FIG. 5 (S4). At this time, the transport unit 15 returns the banknote or banknotes in the temporary storage unit 17 to the first storage unit 23A through the third diversion path 153, the loop-shaped transport path 150, the fifth diversion path 155, and the sixth diversion path 156 as indicated by an arrow B4 in FIG. 6D, for example. While or after the banknote or banknotes are returned to the first storage unit 23A, the control unit 18 updates the serial number list or the like in the memory unit 34. As a result of the processing described above, the numbers of banknotes stored in the temporary storage unit 17, the first storage unit 23A, and the second storage units 23B are as illustrated in FIG. 6E. Note that, when the banknote or banknotes are returned to the first storage unit 23A, recognition processing by the recognition unit 16 may be performed.

Thereafter, the transport unit 15 returns the banknotes temporarily stored in the second storage units 23B to the first storage unit 23A as illustrated in FIG. 5 (S5). At this time, the transport unit 15 returns the banknotes in the second storage units 23B to the first storage unit 23A through each of the sixth diversion paths 156 and the fifth diversion path 155 as indicated by an arrow B5 in FIG. 6E, for example. While or after the banknotes are returned to the first storage unit 23A, the control unit 18 updates the serial number list or the like in the memory unit 34. As a result of the processing described above, the numbers of banknotes stored in the temporary storage unit 17, the first storage unit 23A, and the second storage units 23B are as illustrated in FIG. 6A, and the reconciliation processing ends.

### (1-3) Working Effects of Embodiment 1

According to Embodiment 1, even when the temporary storage unit 17 in which the maximum number of banknotes stored therein is smaller than the maximum number of banknotes stored in the first storage unit 23A is used, it is possible to perform reconciliation processing of every banknote in the first storage unit 23A by temporarily storing the banknotes in the first storage unit 23A in the second storage units 23B and the temporary storage unit 17, respectively. Accordingly, it is possible to reduce the placement space for the temporary storage unit 17 and to miniaturize the sheet processing apparatus 1.

Since a configuration in which banknotes are wound and stored is applied as the first storage unit 23A, the second storage units 23B, and the temporary storage unit 17, banknotes having different sizes can be stored in the one first storage unit 23A, the second storage units 23B or the temporary storage unit 17 as needed.

In the temporary storage unit 17 (see FIG. 2), a banknote can be transported while being held between the second tapes 174A and 174B located on both sides of the banknote, respectively, between the second rollers 172A and 172B and the second drum 173. Accordingly, it is possible to ensure that a banknote is wound around the second drum 173. Further, in the first storage unit 23A and the second storage units 23B, a banknote and the first tapes located on one side of the banknote are wound around the first drum 232 while the banknote overlaps the first tapes so that it is possible to reduce the thickness of a wound product in comparison with a configuration as in the temporary storage unit 17 in which a banknote is wound together with tapes located on both sides of the banknote, respectively. Accordingly, it is possible to increase the maximum numbers of banknotes stored in the first storage unit 23A and the second storage units 23B without increasing the placement spaces for the first storage unit 23A and the second storage units 23B.

Since the maximum number of banknotes stored in the first storage unit 23A and the maximum numbers of banknotes stored in the second storage units 23B are configured to be equal to each other, it is possible to use a common unit.

Since recognition processing of a denomination of banknotes and a number of the banknotes is performed as the reconciliation processing, it is possible to guarantee the number of banknotes stored in the first storage 23A, the serial number list thereof, the inventory amount therein and the like.

Since the first storage unit 23A and the second storage units 23B are housed in the storage box 20 formed of the safe, and the recognition unit 16 and the temporary storage unit 17 are disposed outside the storage box 20, it is possible to miniaturize the sheet processing apparatus 1 having the general structure as such.

### (2) Embodiment 2

### (2-1) Configuration of Sheet Processing Apparatus

Next, a sheet processing apparatus according to Embodiment 2 of the present disclosure will be described. Note that, a description will be given by denoting the same configurations as those in the sheet processing apparatus 1 of Embodiment 1 with the same names and the same reference signs.

As illustrated in FIG. 1A, a sheet processing apparatus 1A of Embodiment 2 differs from the sheet processing apparatus 1 of Embodiment 1 in the configurations of the depositing unit 12 and the dispensing unit 13. Specifically, the depositing unit 12 comprises, in addition to the configurations in Embodiment 1, a depositing shutter 122 indicated by a two-dot chain line. The depositing shutter 122 opens and closes the inlet 121 by sliding near the opening of the inlet 121. The dispensing unit 13 comprises, in addition to the configurations in Embodiment 1, a dispensing shutter 132 indicated by a two-dot chain line, and a retract mechanism. The dispensing shutter 132 opens and closes the outlet 131 by sliding near the opening of the outlet 131. The retract mechanism takes in a banknote in the outlet 131 into the second diversion path 152.

### (2-2) Reconciliation Processing of Sheet Processing Apparatus

Reconciliation processing in the sheet processing apparatus 1A will be described. The difference between the reconciliation processing of Embodiment 1 and the reconciliation processing of Embodiment 2 is that in Embodiment 1, the first winding storage units 23 other than the first storage unit 23A are applied as the second storage unit of the present disclosure, whereas in Embodiment 2, the inlet 121 and the outlet 131 are applied as the second storage unit of the present disclosure. Table 2 indicates configurations corresponding to the first storage unit, the second storage unit and the third storage unit of the present disclosure in Embodiment 2, respectively.

TABLE 2

| | |
|---|---|
| First storage unit | First winding storage unit 23 on the upper-left side |
| Second storage unit | Inlet 121 and outlet 131 |
| Third storage unit | Temporary storage unit 17 |

The reconciliation processing of Embodiment 2 is performed based on the flow chart of FIG. 5 in Embodiment 1. Specifically, when reconciliation for the first storage unit (hereinafter referred to as “first winding storage unit 23 on the upper-left side” in the description of this reconciliation processing) is performed, the depositing shutter 122 and dispensing shutter 132 close the inlet 121 and the outlet 131. Next, the control unit 18 controls each unit of the sheet processing apparatus 1A such that one or some banknotes in the first winding storage unit 23 on the upper-left side are recognized by the recognition unit 16 and are temporarily stored in the third storage unit (hereinafter referred to as “temporary storage unit 17” in the description of this reconciliation processing) (S1). Next, the transport unit 15 temporarily stores the banknotes temporarily stored in the temporary storage unit 17 in the second storage unit (hereinafter referred to as “at least one of the inlet 121 and the outlet 131” in the description of this reconciliation processing) (S2). Thereafter, the control unit 18 controls each unit of the sheet processing apparatus 1A such that remaining banknote or banknotes in the first winding storage unit 23 on the upper left side are recognized by the recognition unit 16 and are temporarily stored in the temporary storage unit 17 (S3). Thereafter, the transport unit 15 returns the banknote or banknotes temporarily stored in the temporary storage unit 17 to the first winding storage unit 23 on the upper-left side (S4). Then the transport unit 15 returns the banknotes temporarily stored in at least one of the inlet 121 and the outlet 131 to the first winding storage unit 23 on the upper-left side (S5). The reconciliation processing ends with the above-described processing.

### (2-3) Working Effects of Embodiment 2

Embodiment 2 achieves the following working effect in addition to the same working effects as those of Embodiment 1. The inlet 121 and the outlet 131 generally comprised by the sheet processing apparatus 1A can be effectively utilized as the second storage unit that temporarily stores banknotes at the time of reconciliation processing.

### (3) Embodiment 3

### (3-1) Configuration of Sheet Processing Apparatus

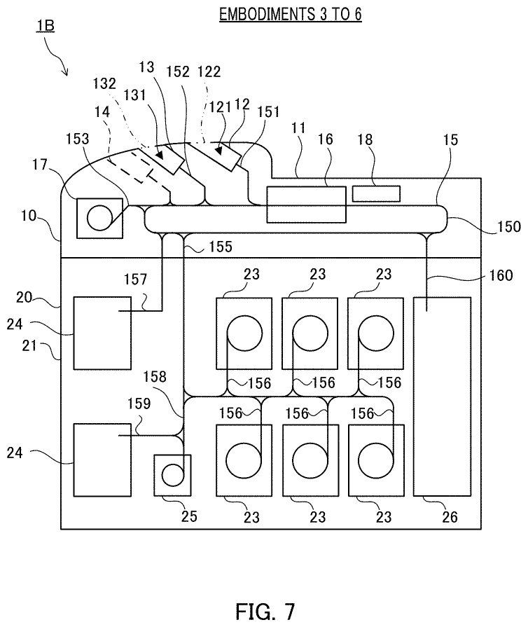

Next, a sheet processing apparatus according to Embodiment 3 of the present disclosure will be described. FIG. 7 is a schematic view illustrating an internal structure of a sheet processing apparatus 1B. Note that, a description will be given by denoting the same configurations as those in the sheet processing apparatus 1 of Embodiment 1 with the same names and the same reference signs.

The sheet processing apparatus 1B illustrated in FIG. 7 differs from the sheet processing apparatus 1 according to Embodiment 1 in the configuration of the transport unit 15 and the configuration inside the storage box 20. The transport unit 15 comprises the first diversion path 151 to the third diversion path 153, the fifth diversion path 155, the sixth diversion path 156, a seventh diversion path 157, an eighth diversion path 158, a ninth diversion path 159, and a tenth diversion path 160.

Inside the storage box 20, in order from the front portion thereof, two first stacking storage units 24, one second winding storage unit 25, six first winding storage units 23, and one second stacking storage unit 26 are disposed.

Of the two first stacking storage units 24, the first stacking storage unit 24 on the upper side is connected to the loop-shaped transport path 150 via the seventh diversion path 157. The first stacking storage unit 24 on the lower side is connected to the loop-shaped transport path 150 via the eighth diversion path 158 diverged from the fifth diversion path 155 and via the ninth diversion path 159 diverged from the eighth diversion path 158. The first stacking storage unit 24 is configured in the same manner as the multipurpose storage unit 22 of Embodiment 1, and is configured to be capable of stacking and storing banknotes on a stacking table and feeding out banknotes stacked on the stacking table to the seventh diversion path 157 or the ninth diversion path 159 one by one from above.

Note that, the first stacking storage unit 24 comprising two storage compartments along the vertical direction may also be provided. In this case, the seventh diversion path 157 is connected to the storage compartment in an upper portion of the first stacking storage unit 24, and the ninth diversion path 159 is connected to the storage compartment in a lower portion of the first stacking storage unit 24.

The second winding storage unit 25 is connected to the loop-shaped transport path 150 via the eighth diversion path 158 and the fifth diversion path 155. The second winding storage unit 25 is configured to wind and store banknotes. The second winding storage unit 25 is configured such that the maximum number of banknotes stored therein is smaller than the maximum number of banknotes stored in the first winding storage unit 23. The second winding storage unit 25 may also be configured such that two tapes and a banknote held between the tapes are wound while the tapes and the banknote overlap each other as in the temporary storage unit 17 or may be configured such that a banknote and tapes located on one side of the banknote are wound while the banknote overlaps the tapes as in the first winding storage unit 23.

The second stacking storage unit 26 is connected to the tenth diversion path 160 diverged from the loop-shaped transport path 150. The second stacking storage unit 26 is configured such that the maximum number of banknotes stored therein is larger than the maximum number of banknotes stored in the first stacking storage unit 24. The second stacking storage unit 26 is configured in the same manner as the first stacking storage unit 24, and is configured to be capable of stacking and storing banknotes on a stacking table and feeding out banknotes stacked on the stacking table to the tenth diversion path 160 one by one from above.

Each of the first stacking storage unit 24, the second winding storage unit 25, and the second stacking storage unit 26 comprises sensors that detect a banknote during transport. When detection signals of these sensors are inputted, the control unit 18 outputs a control signal based on the detection signals, and controls each unit forming the sheet processing apparatus 1B such that the banknote is transported among the depositing unit 12, the dispensing unit 13, the temporary storage unit 17, the first winding storage unit 23, the first stacking storage unit 24, the second winding storage unit 25, and the second stacking storage unit 26 via the transport unit 15.

### (3-2) Reconciliation Processing of Sheet Processing Apparatus

Reconciliation processing in the sheet processing apparatus 1B will be described. Table 3 indicates configurations corresponding to the first storage unit, the second storage unit and the third storage unit of the present disclosure in Embodiment 3, respectively.

TABLE 3

| | |
|---|---|
| First storage unit | Second stacking storage unit 26 |
| Second storage unit | All first winding storage units 23, all first stacking |
| | storage units 24, second winding storage unit 25 |
| Third storage unit | Temporary storage unit 17 |

When reconciliation for the first storage unit (hereinafter referred to as “second stacking storage unit 26” in the description of this reconciliation processing) is performed, the control unit 18 controls each unit of the sheet processing apparatus 1B such that one or some banknotes in the second stacking storage unit 26 are recognized by the recognition unit 16 and are temporarily stored in the third storage unit (hereinafter referred to as “temporary storage unit 17” in the description of this reconciliation processing) as illustrated in FIG. 5 (S1). Next, the transport unit 15 temporarily stores the banknotes temporarily stored in the temporary storage unit 17 in the second storage unit (hereinafter referred to as “at least one of all the first winding storage units 23, all the first stacking storage units 24, and the second winding storage unit 25” in the description of this reconciliation processing) (S2). Thereafter, the control unit 18 controls each unit of the sheet processing apparatus 1B such that remaining banknote or banknotes in the second stacking storage unit 26 are recognized by the recognition unit 16 and are temporarily stored in the temporary storage unit 17 (S3). Thereafter, the transport unit 15 returns the banknote or banknotes temporarily stored in the temporary storage unit 17 to the second stacking storage unit 26 (S4). Then the transport unit 15 returns the banknotes temporarily stored in at least one of all the first winding storage units 23, all the first stacking storage units 24, and the second winding storage unit 25 to the second stacking storage unit 26 (S5). The reconciliation processing ends with the above-described processing.

### (3-3) Working Effects of Embodiment 3

According to Embodiment 3, even when the temporary storage unit 17 in which the maximum number of banknotes stored therein is smaller than the maximum number of banknotes stored in the second stacking storage unit 26 is used, it is possible to perform reconciliation processing of every banknote in the second stacking storage unit 26 by temporarily storing the banknotes in the second stacking storage unit 26 in the first winding storage units 23, the first stacking storage units 24, the second winding storage unit 25, and the temporary storage unit 17, respectively. Accordingly, it is possible to reduce the placement space for the temporary storage unit 17 and to miniaturize the sheet processing apparatus 1B.

### (4) Embodiment 4

### (4-1) Reconciliation Processing of Sheet Processing Apparatus

Embodiment 4 of the present disclosure is the same as Embodiment 3 in terms of using the sheet processing apparatus 1B, but places where banknotes are temporarily stored differ between Embodiments 3 and 4. Table 4 indicates configurations corresponding to the first storage unit, the second storage unit and the third storage unit of the present disclosure in Embodiment 4, respectively. Note that, although a case where the first stacking storage unit 24 on the upper side is applied as the third storage unit of the present disclosure is exemplified in Embodiment 4, the first stacking storage unit 24 on the lower side may be applied.

TABLE 4

| | |
|---|---|
| First storage unit | Second stacking storage unit 26 |
| Second storage unit | Temporary storage unit 17, all first winding storage |
| | units 23, second winding storage unit 25 |
| Third storage unit | First stacking storage unit 24 on the upper side |

When reconciliation for the first storage unit (hereinafter referred to as “second stacking storage unit 26” in the description of this reconciliation processing) is performed, the control unit 18 controls each unit of the sheet processing apparatus 1B such that one or some banknotes in the second stacking storage unit 26 are recognized by the recognition unit 16 and are temporarily stored in the third storage unit (hereinafter referred to as “first stacking storage unit 24 on the upper side” in the description of this reconciliation processing) as illustrated in FIG. 5 (S1). Next, the transport unit 15 temporarily stores the banknotes temporarily stored in the first stacking storage unit 24 on the upper side in the second storage unit (hereinafter referred to as “at least one of the temporary storage unit 17, all the first winding storage units 23, and the second winding storage unit 25” in the description of this reconciliation processing) (S2). Thereafter, the control unit 18 controls each unit of the sheet processing apparatus 1B such that remaining banknote or banknotes in the second stacking storage unit 26 are recognized by the recognition unit 16 and are temporarily stored in the first stacking storage unit 24 on the upper side (S3). Thereafter, the transport unit 15 returns the banknote or banknotes temporarily stored in the first stacking storage unit 24 on the upper side to the second stacking storage unit 26 (S4). Then the transport unit 15 returns the banknotes temporarily stored in at least one of the temporary storage unit 17, all the first winding storage units 23, and the second winding storage unit 25 to the second stacking storage unit 26 (S5). The reconciliation processing ends with the above-described processing.

### (4-2) Working Effects of Embodiment 4

According to Embodiment 4, even when one first stacking storage unit 24 in which the maximum number of banknotes stored therein is smaller than the maximum number of banknotes stored in the second stacking storage unit 26 is used, it is possible to perform reconciliation processing of every banknote in the second stacking storage unit 26 by temporarily storing the banknotes in the second stacking storage unit 26 in the temporary storage unit 17, the first winding storage units 23, the one first stacking storage unit 24, and the second winding storage unit 25, respectively. Accordingly, it is possible to reduce the placement spaces for the first stacking storage units 24 and to miniaturize the sheet processing apparatus 1B.

### (5) Embodiment 5

### (5-1) Reconciliation Processing of Sheet Processing Apparatus

Embodiment 5 of the present disclosure is the same as Embodiment 3 in terms of using the sheet processing apparatus 1B, but places where banknotes are temporarily stored differ between Embodiments 3 and 5. Table 5 indicates configurations corresponding to the first storage unit, the second storage unit and the third storage unit of the present disclosure in Embodiment 5, respectively.

TABLE 5

| | |
|---|---|
| First storage unit | First winding storage unit 23 on the upper-left side |
| Second storage unit | All first stacking storage units 24, second winding |
| | storage unit 25, second stacking storage unit 26 |
| Third storage unit | Temporary storage unit 17 |

When reconciliation for the first storage unit (hereinafter referred to as “first winding storage unit 23 on the upper-left side” in the description of this reconciliation processing) is performed, the control unit 18 controls each unit of the sheet processing apparatus 1B such that one or some banknotes in the first winding storage unit 23 on the upper-left side are recognized by the recognition unit 16 and are temporarily stored in the third storage unit (hereinafter referred to as “temporary storage unit 17” in the description of this reconciliation processing) as illustrated in FIG. 5 (S1). Next, the transport unit 15 temporarily stores the banknotes temporarily stored in the temporary storage unit 17 in the second storage unit (hereinafter referred to as “at least one of all the first stacking storage units 24, the second winding storage unit 25, and the second stacking storage unit 26” in the description of this reconciliation processing) (S2). Thereafter, the control unit 18 controls each unit of the sheet processing apparatus 1B such that remaining banknote or banknotes in the first winding storage unit 23 on the upper-left side are recognized by the recognition unit 16 and are temporarily stored in the temporary storage unit 17 (S3). Thereafter, the transport unit 15 returns the banknote or banknotes temporarily stored in the temporary storage unit 17 to the first winding storage unit 23 on the upper-left side (S4). Then the transport unit 15 returns the banknotes temporarily stored in at least one of all the first stacking storage units 24, the second winding storage unit 25, and the second stacking storage unit 26 to the first winding storage unit 23 on the upper-left side (S5). The reconciliation processing ends with the above-described processing.

### (5-2) Working Effects of Embodiment 5

According to Embodiment 5, even when the temporary storage unit 17 in which the maximum number of banknotes stored therein is smaller than the maximum number of banknotes stored in one of the first winding storage units 23 is used, it is possible to perform reconciliation processing of every banknote in one first winding storage unit 23 by temporarily storing the banknotes in the one first winding storage unit 23 in the temporary storage unit 17, the first stacking storage units 24, the second winding storage unit 25, and the second stacking storage unit 26, respectively. Accordingly, it is possible to reduce the placement space for the temporary storage unit 17 and to miniaturize the sheet processing apparatus 1B.

### (6) Embodiment 6

### (6-1) Reconciliation Processing of Sheet Processing Apparatus

Embodiment 6 of the present disclosure is the same as Embodiment 3 in terms of using the sheet processing apparatus 1B, but places where banknotes are temporarily stored differ between Embodiments 3 and 6. Further, as reconciliation processing, denomination recognition using the recognition unit 16 is not performed and only the number of banknotes is detected using the sensors of the second winding storage unit 25 in Embodiment 6. As the sensors of the second winding storage unit 25, the same configurations as the first sensor 234 and the second sensor 235 illustrated in FIG. 1B may be applied, for example. Table 6 indicates configurations corresponding to the first storage unit, the second storage unit and the third storage unit of the present disclosure in Embodiment 6, respectively.

TABLE 6

| | |
|---|---|
| First storage unit | First winding storage unit 23 on the upper-left side |
| Second storage unit | First winding storage units 23 other than first |
| | winding storage unit 23 on the upper-left side, |
| | all first stacking storage units 24 |
| Third storage unit | Second winding storage unit 25 |

When reconciliation for the first storage unit (hereinafter referred to as “first winding storage unit 23 on the upper-left side” in the description of this reconciliation processing) is performed, the control unit 18 controls each unit of the sheet processing apparatus 1B such that one or some banknotes in the first winding storage unit 23 on the upper-left side are not taken out from the storage box 20, but are temporarily stored in the third storage unit (hereinafter referred to as “second winding storage unit 25” in the description of this reconciliation processing). At the time of this storage, the sensors of the second winding storage unit 25, which are an example of the detection sensor of the present disclosure, detect the number of the stored banknotes, and output detection signals to the control unit 18. During or after this temporary storage, the control unit 18 updates the number of banknotes stored in the second winding storage unit 25, where the number of banknotes has been recorded in the memory unit 34, based on the detection signals from the second winding storage unit 25. Next, the transport unit 15 does not take out the banknotes temporarily stored in the second winding storage unit 25 from the storage box 20, but temporarily stores the banknotes in the second storage unit (hereinafter referred to as “at least one of the first winding storage units 23 other than the first winding storage unit 23 on the upper-left side and all the first stacking storage units 24” in the description of this reconciliation processing). Thereafter, the transport unit 15 does not take out remaining banknote or banknotes in the first winding storage unit 23 on the upper-left side from the storage box 20, but temporarily stores the banknote or banknotes in the second winding storage unit 25. At the time of this storage, the control unit 18 also updates the number of banknotes stored in the second winding storage unit 25 based on the detection signals from the second winding storage unit 25. Thereafter, the transport unit 15 does not take out the banknote or banknotes temporarily stored in the second winding storage unit 25 from the storage box 20, but returns the banknote or banknotes to the first winding storage unit 23 on the upper-left side. Then the transport unit 15 does not take out the banknotes temporarily stored in at least one of the first winding storage units 23 other than the first winding storage unit 23 on the upper-left side and all the first stacking storage units 24 from the storage box 20, but returns the banknotes to the first winding storage unit 23 on the upper-left side. The reconciliation processing ends with the above-described processing.

### (6-2) Working Effects of Embodiment 6

According to Embodiment 6, even when the second winding storage unit 25 in which the maximum number of banknotes stored therein is smaller than the maximum number of banknotes stored in one of the first winding storage units 23 is used, it is possible to perform detection processing of the number of every banknote in the one first winding storage unit 23 by temporarily storing the banknotes in the one first winding storage unit 23 in the first winding storage units 23 other than the one first winding storage unit 23, the first stacking storage units 24, and the second winding storage unit 25, respectively. Accordingly, it is possible to reduce the placement space for the second winding storage unit 25 and to miniaturize the sheet processing apparatus 1B. Further, it is possible to perform detection processing of the number of banknotes without taking out the banknotes from the storage box 20. Further, since the movement distance of banknotes can be shortened in comparison with a case where banknotes are taken out from the storage box 20 and detection processing of the number of the banknotes is performed, it is possible to reduce the risk of jams of banknotes.

### (7) Embodiment 7

### (7-1) Mixed Dispensing Processing of Sheet Processing Apparatus

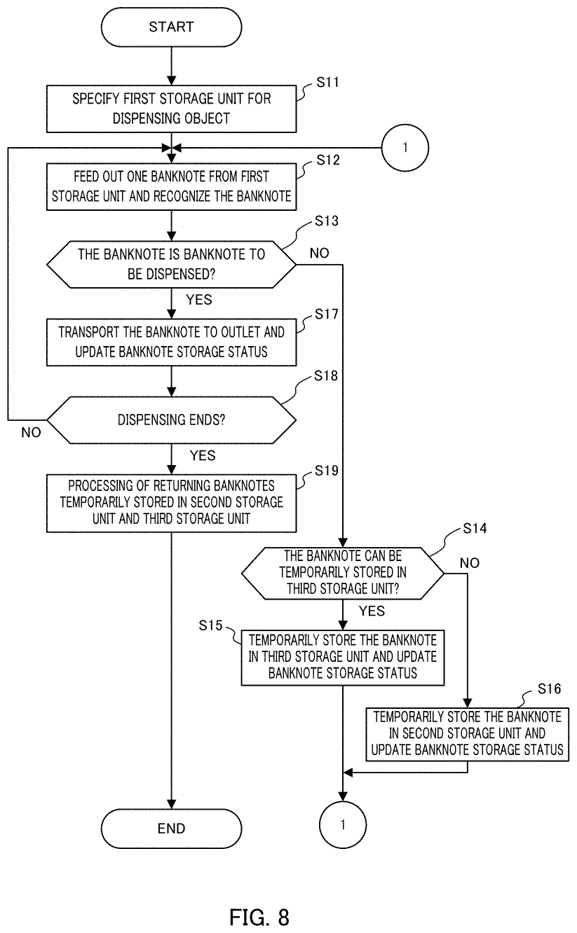

Next, as Embodiment 7 of the present disclosure, mixed dispensing processing using the sheet processing apparatus 1 of Embodiment 1 will be described. The mixed dispensing processing refers to processing of dispensing a banknote of a predetermined denomination from one first winding storage unit 23 in which banknotes of a plurality of denominations are stored. FIG. 8 illustrates a flowchart for the mixed dispensing processing. Note that, configurations corresponding to the first storage unit, the second storage unit, and the third storage unit of the present disclosure in Embodiment 7, respectively, are as illustrated in Table 1.

An operator inputs a command to start dispensing processing for specifying a denomination of banknotes and a number of the banknotes into the sheet processing apparatus 1 by operating the higher-ranking terminal or the operation unit 32. As illustrated in FIG. 8, the control unit 18 specifies, as the first storage unit, one first winding storage unit 23 capable of dispensing the number of banknotes of the denomination to be dispensed (hereinafter referred to as “first winding storage unit 23 for the dispensing object” in the description of this mixed dispensing processing) based on the serial number list and denomination of each of the first winding storage units 23, which have been recorded in the memory unit 34 (S11).

Next, the control unit 18 controls each unit of the sheet processing apparatus 1 such that one banknote is fed out from the first winding storage unit 23 for the dispensing object, is transported to the recognition unit 16 via the sixth diversion path 156, the fifth diversion path 155, and the loop-shaped transport path 150, and is recognized by the recognition unit 16 (S12). The control unit 18 then determines whether the recognized banknote is a banknote to be dispensed (S13).

In a case where the control unit 18 determines that the recognized banknote is not a banknote to be dispensed (S13: NO), the control unit 18 determines whether the banknote can be temporarily stored in the third storage unit (hereinafter referred to as “temporary storage unit 17” in the description of this mixed dispensing processing) (S14). In a case where the control unit 18 determines that the banknote can be temporarily stored in the temporary storage unit 17 (S14: YES), the control unit 18 causes the transport unit 15 to temporarily store the banknote in the temporary storage unit 17, and updates the banknote storage status of the first winding storage unit 23 for the dispensing object and the temporary storage unit 17, where the banknote storage status has been recorded in the memory unit 34 (S15). In a case where the control unit 18 determines that the banknote cannot be temporarily stored in the temporary storage unit 17 (S14: NO), on the other hand, the control unit 18 causes the transport unit 15 to temporarily store the banknote in the second storage unit (hereinafter referred to as “first winding storage units 23 not for the dispensing object” in the description of this mixed dispensing processing), and updates the banknote storage status of the first winding storage unit 23 for the dispensing object and the first winding storage units 23 not for the dispensing object (S16). When the control unit 18 has caused the processing in S15 or S16 to be performed, the control unit 18 causes the processing in S12 to be performed.

Further, in a case where the control unit 18 determines that the banknote recognized by the recognition unit 16 is a banknote to be dispensed (S13: YES), the control unit 18 causes the transport unit 15 to transport the banknote to the outlet 131, and updates the banknote storage status of the first winding storage unit 23 for the dispensing object (S17). Thereafter, the control unit 18 determines whether to end the dispensing (S18). In a case where the control unit 18 determines that transport of every banknote to be dispensed to the outlet 131 is not completed and the dispensing is not ended (S18: NO), the control unit 18 causes the processing in S12 to be performed. In a case where the control unit 18 determines that the transport of every banknote to be dispensed to the outlet 131 is completed and the dispensing is ended (S18: YES), on the other hand, the control unit 18 controls the transport unit 15 such that banknotes temporarily stored in the first winding storage units 23 not for the dispensing object and the temporary storage unit 17 are returned to the first winding storage unit 23 for the dispensing object (S19). The mixed dispensing processing ends with the above-described processing.

Here, when temporarily stored banknotes are returned to the first winding storage unit 23 for the dispensing object in the processing in S19, the control unit 18 may recognize a denomination whose banknotes are frequently dispensed, based on banknote storage status recorded in the memory unit 34, and the transport unit 15 may return the temporarily stored banknotes to the first winding storage unit 23 for the dispensing object such that banknotes of the denomination recognized by the control unit 18 can be preferentially dispensed at the time of the next mixed dispensing. That is, banknotes of a denomination which are not frequently dispensed may be first returned to the first winding storage unit 23 for the dispensing object and then banknotes of a denomination which are frequently dispensed may be returned to the first winding storage unit 23 for the dispensing object. Note that, the concept of preferentially dispensing banknotes of a denomination which are frequently dispensed also comprises, in addition to the concept of first dispensing banknotes of a denomination which are frequently dispensed, the concept of first dispensing several banknotes of a denomination which are not frequently dispensed and then dispensing banknotes of denomination which are frequently dispensed. Such a configuration makes it possible to end the mixed dispensing quickly. Further, the transport unit 15 may return every banknote temporarily stored in the temporary storage unit 17 to the first winding storage unit 23 for the dispensing object and then return every banknote temporarily stored in the first winding storage units 23 not for the dispensing object to the first winding storage unit 23 for the dispensing object.

### (7-2) Working Effects of Embodiment 7

According to Embodiment 7, even when the temporary storage unit 17 in which the maximum number of banknotes stored therein is smaller than one of the first winding storage units 23 is used, it is possible to perform mixed dispensing processing of banknotes in the one first winding storage unit 23 by temporarily storing the banknotes in the one first winding storage unit 23 in the first winding storage units 23 other than the one first winding storage unit 23 and the temporary storage unit 17. Accordingly, it is possible to reduce the placement space for the temporary storage unit 17 and to miniaturize the sheet processing apparatus 1.

### (8) Reference Embodiment

Next, as a reference embodiment of the present disclosure, reconciliation processing using the sheet processing apparatus 1 of Embodiment 1 will be described. In the reconciliation processing in the reference embodiment, denomination recognition using the recognition unit 16 is not performed and only detection of the number of banknotes by using the sensors of the first winding storage unit 23 is performed.

When reconciliation for the first winding storage unit 23 on the upper-left side (the first storage unit) is performed, the transport unit 15 does not take out every banknote in the first storage unit from the storage box 20, but temporarily stores the banknotes in the first winding storage units 23 (the second storage unit) other than the first storage unit. At the time of this storage, the control unit 18 updates, based on detection signals from the first sensor 234 and the second sensor 235 of the second storage unit, the number of banknotes stored in the second storage unit, where the number of banknotes has been recorded in the memory unit 34. Thereafter, the transport unit 15 does not take out the banknotes temporarily stored in the second storage unit from the storage box 20, but returns the banknotes to the first storage unit, and the control unit 18 updates the number of banknotes stored in the second storage unit. The reconciliation processing ends with the above-described processing.

According to the reference embodiment described above, it is possible to perform detection processing of the number of banknotes without taking out the banknotes from the storage box 20.

### (9) Variations

Although specific embodiments of the present disclosure have been described in detail thus far, these are merely illustrative, and the specific embodiments illustrated above may be variously modified and changed.

For example, in Embodiments 1 to 5, the processing in S4 and the processing in S5 may be interchanged. In the same manner, in Embodiment 6, the banknotes temporarily stored in at least one of the first winding storage units 23 other than the first winding storage unit 23 on the upper-left side and all the first stacking storage units 24 (the second storage unit) may be returned to the first winding storage unit 23 on the upper-left side (the first storage unit) and then the banknotes temporarily stored in the second winding storage unit 25 (the third storage unit) may be returned to the first winding storage unit 23 on the upper-left side. In these cases, the order in which banknotes are stored in the first storage unit after reconciliation processing differs from the order in which banknotes are stored in the first storage unit before the reconciliation processing so that the serial number list is preferably updated in accordance with the order in which banknotes are stored in the first storage unit after the reconciliation processing.

In Embodiments 1 to 5, the destinations in which banknotes are temporarily stored in the reconciliation processing in S1 to S5 of FIG. 5 may be configured as follows. First, the control unit 18 causes one or some banknotes in the first storage unit to be recognized by the recognition unit 16 and to be temporarily stored in the second storage unit. Next, the control unit 18 causes the banknotes temporarily stored in the second storage unit to be temporarily stored in the third storage unit. Thereafter, the control unit 18 causes remaining banknote or banknotes in the first storage unit to be recognized by the recognition unit 16 and to be temporarily stored in the second storage unit. Thereafter, the control unit 18 causes the banknote or banknotes temporarily stored in one of the second storage unit and the third storage unit to be returned to the first storage unit. Then, the control unit 18 causes the banknote or banknotes temporarily stored in the other one of the second storage unit and the third storage unit to be returned to the first storage unit.

In Embodiment 6, the destinations in which banknotes are temporarily stored in the reconciliation processing may be configured as follows. First, the control unit 18 causes one or some banknotes in the first storage unit not to be taken out from the storage box 20, but to be temporarily stored in the second storage unit. Next, the control unit 18 causes the banknotes temporarily stored in the second storage unit not to be taken out from the storage box 20, but to be temporarily stored in the third storage unit. Thereafter, the control unit 18 causes remaining banknote or banknotes in the first storage unit not to taken out from the storage box 20, but to be temporarily stored in the second storage unit. Thereafter, the control unit 18 causes the banknote or banknotes temporarily stored in one of the second storage unit and the third storage unit not to be taken out from the storage box 20, but to be returned to the first storage unit. Then, the control unit 18 causes the banknote or banknotes temporarily stored in the other one of the second storage unit and the third storage unit not to be taken out from the storage box 20, but to be returned to the first storage unit.

The mixed dispensing processing in Embodiment 7 may be performed using the sheet processing apparatus 1B illustrated in FIG. 7 In this case, the configurations illustrated in Tables 3 to 6 may be applied as configurations corresponding to the “first storage unit”, “second storage unit”, and “third storage unit” illustrated in the flowchart of FIG. 8.

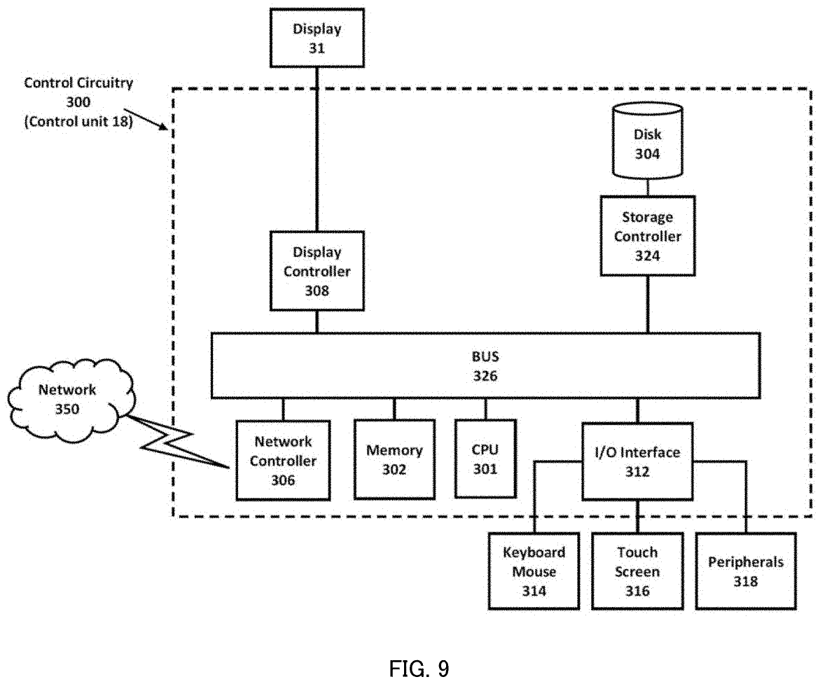

FIG. 9 is a block diagram of control circuitry that performs computer-based operations in accordance with the present disclosure. FIG. 9 illustrates control circuitry 300 of control unit 18, which is a component of sheet processing apparatus 1.

Control circuitry 300 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or control circuitry which may include general purpose processors, special purpose processors, integrated circuits, ASICs (“Application Specific Integrated Circuits”), conventional circuitry and/or combinations thereof which are configured or programmed to perform the disclosed functionality. Processors are control circuitry or circuitry as they include transistors and other circuitry therein. The processor may be a programmed processor which executes a program stored in a memory. In the disclosure, the control circuitry, units, or means are hardware that carry out or are programmed to perform the recited functionality. The hardware may be any hardware disclosed herein or otherwise known which is programmed or configured to carry out the recited functionality.

In FIG. 9, the control circuitry 300 includes a CPU 301 which performs one or more of the control processes discussed in this disclosure. The process data and instructions may be stored in memory 302. These processes and instructions may also be stored on a storage medium disk 504 of the memory unit 34. The storage medium disk 504 may be a hard drive (HDD) or portable storage medium or may store the processes and instructions remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the control circuitry 300 communicates, such as a server or computer. The processes may also be stored in network based storage, cloud-based storage or other mobile accessible storage and executable by control circuitry 300. Further, the claimed advancements may be provided as a utility application, background daemon, or component of an operating system, or combination thereof, executing in conjunction with CPU 301 and an operating system such as Microsoft Windows, UNIX, Solaris, LINUX, Apple MAC-OS, Apple iOS and other systems known to those skilled in the art.

The hardware elements in order to achieve the control circuitry 300 may be realized by various circuitry elements. Further, each of the functions of the above described embodiments may be implemented by circuitry, which includes one or more processing circuits. A processing circuit includes a particularly programmed processor, for example, processor (CPU) 301, as shown in FIG. 9. A processing circuit also includes devices such as an application specific integrated circuit (ASIC) and conventional circuit components arranged to perform the recited functions.

In FIG. 9, the control circuitry 300 may be a computer or a particular, special-purpose machine. Control circuitry 300 is programmed to execute processing to control sheet processing apparatus 1. Alternatively, or additionally, the CPU 301 may be implemented on an FPGA, ASIC, PLD or using discrete logic circuits, as one of ordinary skill in the art would recognize. Further, CPU 301 may be implemented as multiple processors cooperatively working in parallel to perform the instructions of the inventive processes described above.

The control circuitry 300 in FIG. 9 also includes a network controller 306 of communication unit 33, such as an Ethernet PRO network interface card, for interfacing with network 350. As can be appreciated, the network 350 can be a public network, such as the Internet, or a private network such as a local area network (LAN) or wide area network (WAN), or any combination thereof and can also include Public Switched Telephone Network (PSTN) or Integrated Services Digital Network (ISDN) sub-networks or ATM network. The network 350 can also be wired, such as an Ethernet network, universal serial bus (USB) cable, or can be wireless such as a cellular network including EDGE, 4G and 5G wireless cellular systems. The wireless network can also be Wi-Fi, wireless LAN, Bluetooth, or any other wireless form of communication that is known. Additionally, network controller 306 may be compliant with other direct communication standards, such as Bluetooth, a near field communication (NFC), infrared ray or other.

The control circuitry 300 further includes a display controller 308, such as a graphics card or graphics adaptor for interfacing with display 31, such as a monitor. An I/O interface 312 interfaces with a keyboard and/or mouse 314 as well as a touch screen panel 316 on or separate from display 31. The operation unit 32 in FIG. 4 includes the keyboard and/or mouse 314 and the touch screen panel 316. I/O interface 312 also connects to a variety of peripherals 318.

The storage controller 324 connects the storage medium disk 304 with communication bus 326, which may be an ISA, EISA, VESA, PCI, or similar, for interconnecting all of the components of the control circuitry 300. A description of the general features and functionality of the display 31, keyboard and/or mouse 314, as well as the display controller 308, storage controller 324, network controller 306, and I/O interface 312 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). Input to the system may be received via direct user input and received remotely either in real-time or as a batch process. Additionally, some implementations may be performed on modules or hardware not identical to those described. Accordingly, other implementations are within the scope that may be claimed.

### INDUSTRIAL APPLICABILITY

The present disclosure is useful for a sheet processing apparatus that processes a sheet.

### REFERENCE SIGNS LIST

1, 1A, 1B Sheet processing apparatus
10 Processing unit
11 Upper housing
12 Depositing unit
13 Dispensing unit
14 Second dispensing unit
15 Transport unit
16 Recognition unit (detection sensor)
17 Temporary storage unit (third storage unit)
18 Control unit
20 Storage box
21 Lower housing
22 Multipurpose storage unit
23 First winding storage unit (second storage unit)
23A First storage unit
23B Second storage unit
24 First stacking storage unit (second storage unit, third storage unit)
25 Second winding storage unit (second storage unit, third storage unit)
26 Second stacking storage unit (first storage unit, second storage unit)
31 Display
32 Operation unit
33 Communication unit
34 Memory unit
121 Inlet (second storage unit)
122 Depositing shutter
131 Outlet (second storage unit)
132 Dispensing shutter
150 Loop-shaped transport path
151 First diversion path
152 Second diversion path
153 Third diversion path
154 Fourth diversion path
155 Fifth diversion path
156 Sixth diversion path
157 Seventh diversion path
158 Eighth diversion path
159 Ninth diversion path
160 Tenth diversion path
171A, 171B Second reel
172A, 172B Second roller
173 Second drum
174A, 174B Second tape
231 First reel
232 First drum
233 First tape
234 First sensor
235 Second sensor

1. A sheet processing apparatus, comprising:
a transport member configured to transport a sheet;
a detection sensor configured to detect a number of the sheets transported by the transport member;
a first storage, a second storage, and a third storage each of which is configured to store the sheet transported by the transport member; and
a control circuitry, wherein
a maximum number of the sheets stored in the third storage is smaller than a maximum number of the sheets stored in the first storage,
the control circuitry controls the transport member such that the sheets stored in the first storage are temporarily stored in each of the second storage and the third storage, and
the control circuitry controls the detection sensor such that the number of the sheets is detected while the sheets are transported.

2. The sheet processing apparatus according to claim 1, wherein:
a plurality of the second storages is provided along the transport member, and
the control circuitry controls the transport member such that
the sheet stored in the first storage is detected by the detection sensor and is then transported to the third storage, and
the sheet stored in the third storage is preferentially transported to the second storage located on an upstream side of the transport member among the plurality of second storage.

3. The sheet processing apparatus according to claim 1, wherein
a plurality of the second storages is provided along the transport member, and
the control circuitry controls the transport member such that
the sheet stored in the first storage is detected by the detection sensor and is then transported to the third storage, and
the sheet stored in the third storage is preferentially transported to the second storage in which a number of storable sheets is large among the plurality of second storages.

4. The sheet processing apparatus according to claim 1, wherein the first storage, the second storage, and the third storage are configured to wind and store the sheet.

5. The sheet processing apparatus according to claim 1, wherein:
the first storage and the third storage are configured to wind and store the sheet, and
the second storage is an inlet unit, an outlet unit or an inlet and outlet unit, the inlet unit being a unit through which the sheet is placed into the sheet processing apparatus, the outlet unit being a unit through which the sheet is taken out from the sheet processing apparatus, the inlet and outlet unit being a unit through which the sheet is placed into the sheet processing apparatus and is taken out from the sheet processing apparatus.

6. The sheet processing apparatus according to claim 4, wherein:
the first storage comprises a first reel and a first drum, the first reel being a unit around which a first tape is wound, the first drum being connected to the first reel via the first tape, wherein the sheet transported between the first tape before being wound around the first drum and the first tape wound around the first drum on an outermost periphery is wound together with the first tape around the first drum, and
the third storage comprises a pair of second reels and a second drum, the pair of second reels being units around which second tapes are wound, respectively, the second drum being a drum which is connected to the pair of second reels via the second tapes and around which the sheet transported between the second tapes is wound together with the second tapes.

7. The sheet processing apparatus according to claim 1, wherein a maximum number of the sheets stored in the second storage is equal to the maximum number of the sheets stored in the first storage.

8. The sheet processing apparatus according to claim 1, wherein:
when the control circuitry recognizes that it is time to confirm a storage state of the sheet in the first storage, the control circuitry controls the transport member such that
one or some of the sheets stored in the first storage are detected by the detection sensor and are then transported to the third storage, and the one or some of the sheets stored in the third storage are transported to the second storage,
the sheet or sheets that remain stored in the first storage are detected by the detection sensor and are then transported to the third storage, and
the one or some of the sheets stored in the second storage and the sheet or sheets that remain stored in the third storage are returned to the first storage.

9. The sheet processing apparatus according to claim 8, wherein:
the detection sensor detects a type of the sheets and a number of the sheets, and
the control circuitry controls the detection sensor such that the type of the sheets and the number of the sheets are detected while the sheets are transported.

10. The sheet processing apparatus according to claim 1, wherein:
the detection sensor detects a type of the sheets and a number of the sheets,
when the control circuitry recognizes an operation to take out the sheet of a specific type from an outlet unit or an inlet and outlet unit of the sheet processing apparatus, the control circuitry
controls the detection sensor such that the type of the sheets stored in the first storage and the number of the sheets stored in the first storage are detected, and
controls the transport member such that the sheet of the specific type is transported to the outlet unit or the inlet and outlet unit, and that the sheet or sheets other than the sheet of the specific type are temporarily stored in at least one of the second storage and/or the third storage and are then returned to the first storage.

11. The sheet processing apparatus according to claim 10, further comprising a memory unit, wherein
the control circuitry causes the memory unit to record a detection result of the detection sensor and controls the transport member such that the sheets stored in the second storage and the third storage are returned to the first storage so as to cause the sheet of a type that is frequently transported to the outlet unit or the inlet and outlet unit to be preferentially taken out from the first storage.

12. The sheet processing apparatus according to claim 1, wherein:
the sheet is a banknote, and
in depositing processing that the banknote is deposited into the sheet processing apparatus, the control circuitry controls the transport member and the detection sensor such that
the banknote is detected by the detection sensor, and then the banknote is temporarily stored in the third storage,
the banknote stored in the third storage is stored in the first storage, when the control circuitry recognizes an operation to store the banknote in the first storage.

13. The sheet processing apparatus according to claim 12, further comprising a safe that houses the first storage and the second storage, wherein
the third storage and the detection sensor are disposed outside the safe.
